(19) United States
(12) Patent Application Publication
(10) Pub. No.: US 2025/0058168 A1
(43) Pub. Date: Feb. 20, 2025

(54) GAIT TRAINER

(71) Applicant: Life Enabled Inc., West Dundee, IL (US)

(72) Inventors: Timothy Klemm, West Dundee, IL (US); Theodore R. Espiritu, Jr., West Valley City, UT (US); Joseph Heaton, Springville, UT (US); Colter Turley, Odgen, UT (US)

(21) Appl. No.: 18/802,995

(22) Filed: Aug. 13, 2024

Related U.S. Application Data
(60) Provisional application No. 63/519,471, filed on Aug. 14, 2023.

(51) Int. Cl. A63B 22/00; A61H 3/00; A63B 21/00; A63B 21/22

(52) U.S. Cl. CPC A63B 22/0069; A61H 3/00; A63B 21/225; A63B 21/4007; A63B 21/4034; A63B 22/001; A61H 2003/007; A63B 2208/0204; A63B 2208/0233

(57) ABSTRACT

A gait trainer is provided that includes a user support assembly disposed on a base. The user support assembly includes a horizontal support configured to seat a user of the gait trainer, and an actuator attached to the horizontal support. The actuator is configured to articulate at least a portion of the horizontal support from a horizontal configuration into a vertical configuration. The gait trainer further includes a kinematic assembly configured to transmit a physical input from the user of the gait trainer to a flywheel of the kinematic assembly and a restraint configured to constrain a user within the user support assembly during use of the gait trainer.

### RELATED CASES

This application claims priority to U.S. Provisional Application No. 63/519,471, filed on Aug. 14, 2023 and titled “GAIT TRAINER,” which is hereby incorporated by reference in its entirety.

### TECHNICAL FIELD

The present disclosure relates generally to the field of gait trainers.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 illustrates a perspective view of a gait trainer, according to certain embodiments of the present disclosure.

FIG. 2 illustrates a lateral view of the gait trainer of FIG. 1, according to certain embodiments of the present disclosure.

FIG. 3 illustrates a detailed perspective view of a portion of a user support assembly of the gait trainer of FIG. 1, according to certain embodiments of the present disclosure.

FIG. 4 illustrates a standing configuration of the gait trainer of FIG. 1, according to certain embodiments of the present disclosure.

FIG. 5 illustrates a detailed perspective view of a harness and an exoskeleton of the gait trainer of FIG. 1, according to certain embodiments of the present disclosure.

FIG. 6 illustrates a detailed view of a kinematic assembly of the gait trainer of FIG. 1, according to certain embodiments of the present disclosure.

FIG. 7 illustrates a forward position of a foot pedal of the gait trainer of FIG. 1, according to certain embodiments of the present disclosure.

FIG. 8 illustrates a rearward position of a foot pedal of the gait trainer of FIG. 1, according to certain embodiments of the present disclosure.

FIG. 9 illustrates an elevated position of the kinematic assembly of the gait trainer of FIG. 1, according to certain embodiments of the present disclosure.

FIG. 10 illustrates a lowered configuration of the drive handles of the gait trainer of FIG. 1, according to certain embodiments of the present disclosure.

FIG. 11 illustrates a configuration of the gait trainer of FIG. 1 including an increased stride length, according to certain embodiments of the present disclosure.

FIG. 12 illustrates a configuration of the gait trainer of FIG. 1 including a decreased stride length, according to certain embodiments of the present disclosure.

FIG. 13 illustrates an intermediate configuration of the gait trainer of FIG. 1, according to certain embodiments of the present disclosure.

### DETAILED DESCRIPTION

The components of the embodiments as generally described and illustrated in the figures herein can be arranged and designed in a wide variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

The phrase “coupled to” is broad enough to refer to any suitable coupling or other form of interaction between two or more entities, including mechanical interaction. Thus, two components may be coupled to each other even though they are not in direct contact with each other. The phrases “attached to” or “attached directly to” refer to interaction between two or more entities which are in direct contact with each other and/or are separated from each other only by a fastener of any suitable variety (e.g., mounting hardware or an adhesive).

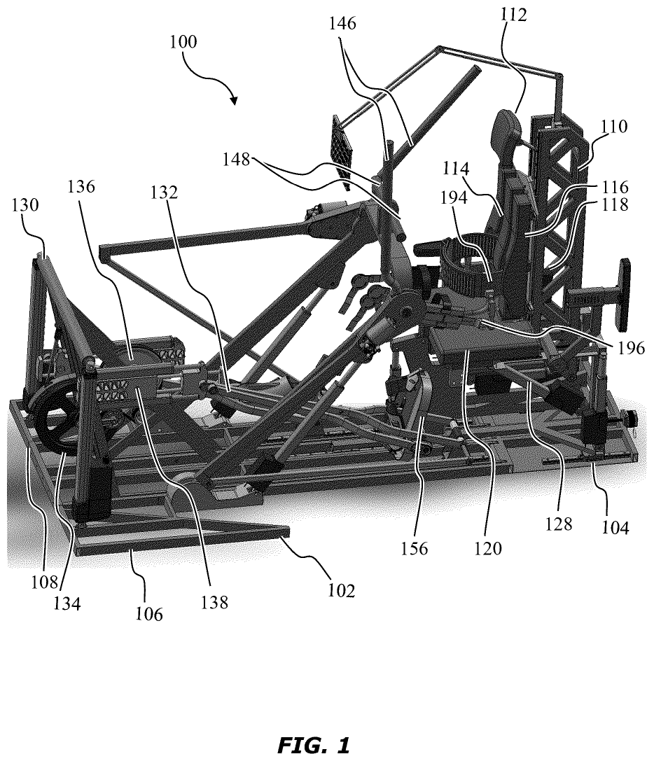

FIG. 1 illustrates a perspective view of a gait trainer 100, according to certain embodiments of the present disclosure. In the illustrated embodiment, gait trainer 100 includes a frame 102 to support a kinematic assembly 130 and a user support assembly 110.

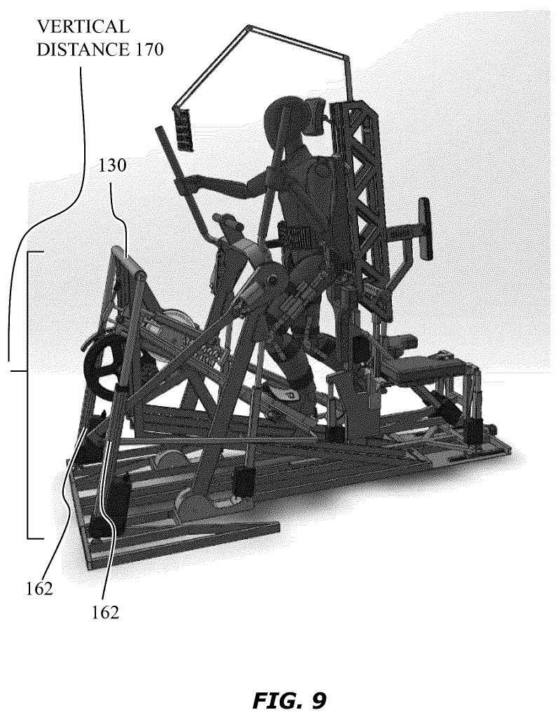

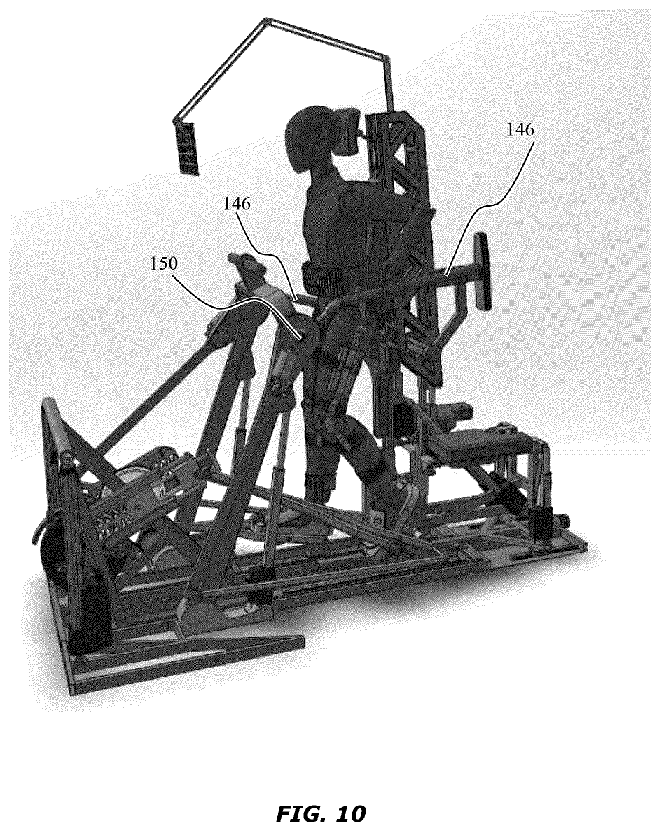

User support assembly 110 includes a vertical support 116 and a horizontal support 120. Vertical support 116 can include an upper portion 112 and lower portion 114. Vertical support 116 can further include a vertical support adjustment mechanism 118 which can adjust the height, width, and angle of upper portion 112 and/or lower portion 114. Horizontal support 120 can include a horizontal support adjustment mechanism 128 which can adjust the height, width, position, and angle of horizontal support 120. In some embodiments, upper portion 112 of vertical support 116 can support the head of a user (not shown in FIG. 1, see FIGS. 9 and 10), while lower portion 114 can support the back, or lumbar, of the user of the gait trainer 100. The user of gait trainer 100 can sit on horizontal support 120, when the gait trainer 100 is within a sitting configuration (e.g., the configuration seen in FIG. 1). In other words, horizontal support 120 in the sitting configuration is a seat that enables the user to sit on gait trainer 100.

A harness (e.g., belt 194) can be used to secure the user to the user support assembly 110. An exoskeleton 196 can further aid in securing the user of gait trainer 100 to user support assembly 110. For instance, belt 194 can serve to hold the user against the user support assembly 110. Exoskeleton 196 can serve to prevent buckling, or movement of knees, thighs, etc. For instance, in some embodiments, exoskeleton 196 can keep the user of gait trainer 100 with a designed path of motion. In the illustrated embodiment, the exoskeleton 196 can be coupled to gait trainer 100. However, in most circumstances, exoskeleton 196 can be attached to the user before they are seated on gait trainer 100 and then the exoskeleton 196 is coupled to gait trainer 100.

Kinematic assembly 130 can include a linkage mechanism 132 connecting drive handles 146 and foot pedals 156 to a flywheel 134. For example, linkage mechanism 132 can connect drive handles 146 and/or foot pedals 156 to a crankshaft 138 and/or drive wheel 136. Accordingly, foot pedals 156 and/or drive handles 146 can be used by the user of the gait trainer 100 to induce rotational motion into the flywheel 134. Otherwise stated, kinematic assembly can be configured to transmit a physical input from the user of the gait trainer 100 (e.g., through foot pedals 156) to a flywheel 134 of the kinematic assembly 130.

When in use, gait trainer 100 can imitate a natural, or training, walking pattern through a coordinated operation of foot pedals 156 and drive handles 146. For instance, foot pedals 156 can replicate normal or natural biomechanical motions of a human gait, including natural foot placement and stride. Drive handles 146 can provide upper body support and synchronize with foot pedals 156 (to imitate a realistic, natural, or training walking gait).

In some embodiments, the user of gait trainer 100 can rely on fixed handles 148 of gait trainer 100 to brace or support themselves against. Alternatively, the user of gait trainer 100 can rely on drive handles 146 to brace or support themselves against.

In some cases, gait trainer 100 can assist the user through an assistive mechanism. For instance, in some embodiments, gait trainer 100 can include an electric motor or assistive drive (not shown in FIG. 1), to alleviate a level of effort for powering gait trainer 100. Gait trainer 100 can offer minimal, or varying, levels of assistance for users, as dictated by the user's current condition.

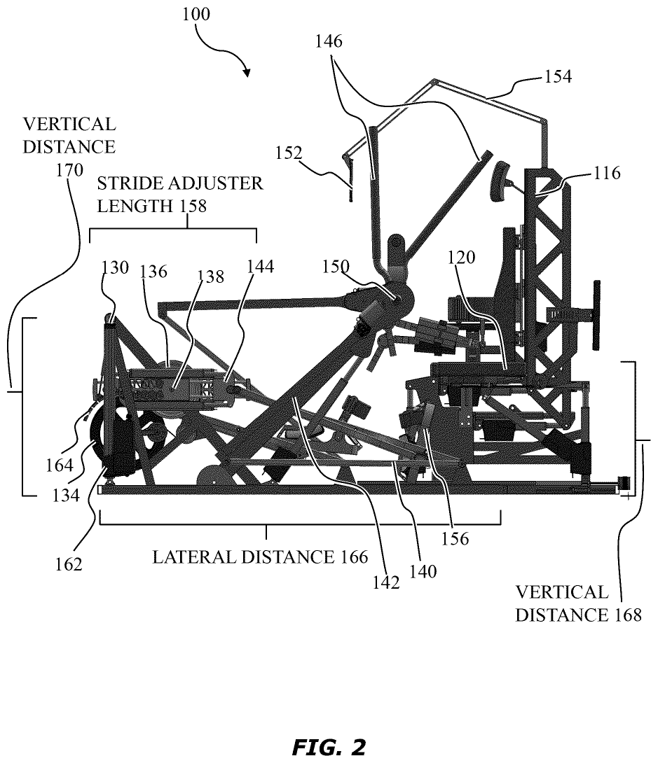

In addition, gait trainer 100 can also provide a resistive force against the user during the movement of the walking pattern. As will be further described with respect to FIG. 2, a resistive mechanism can resist motion or movement of the gait trainer 100. This can enhance muscle strengthening and endurance.

In some cases, the resistive and/or assistive mechanisms can include an emergency brake or clutch mechanism designed to disengage resistance or assistance in the event of an injury or similar incident experienced by the user of gait trainer 100, such as a seizure.

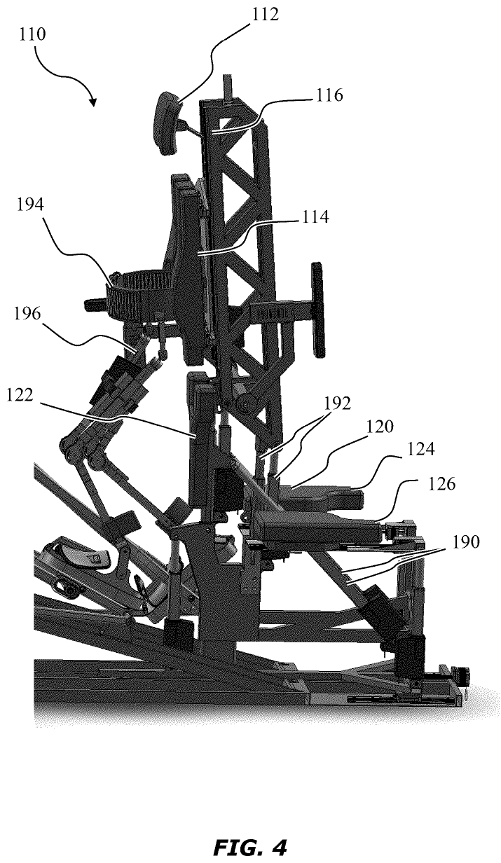

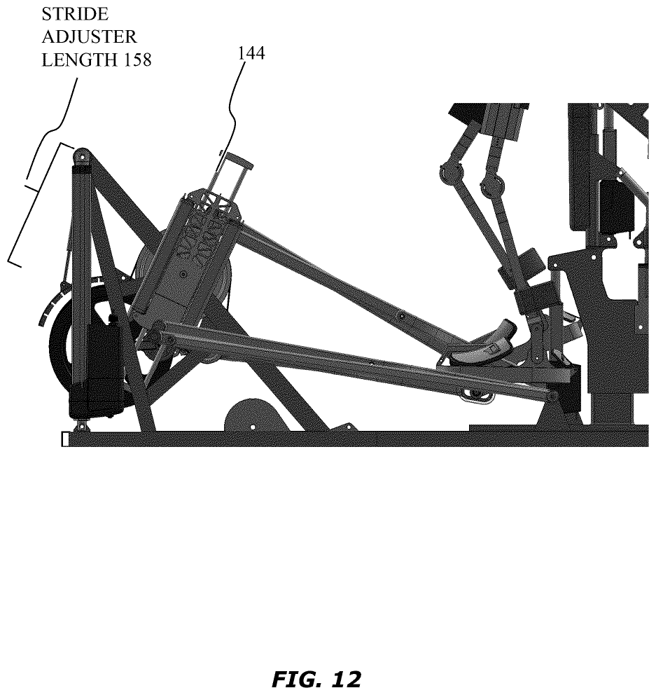

As will be further described with respect to FIGS. 4 and 12, user support assembly 110 can include multiple configurations. In a seated configuration (seen in at least FIG. 1), the user of gait trainer 100 can be mostly seated. In a standing configuration (seen in at least FIG. 4), the user of gait trainer 100 can be mostly standing. Gait trainer 100 can be configured to transition to any intermediate position, between the seated configuration and the standing configuration, as will be further described with respect to FIG. 12.

In some cases, frame 102 (at times referred to as a “base” herein) can include separable portions. For example, frame 102 can be composed of center portion 104, first outer portion 106, and second outer portion 108. First outer portion 106 and/or second outer portion 108 can thus be detached from middle portion 122, which can facilitate passage and transportation of the gait trainer 100 (e.g., through a standard doorway or constricted space). Otherwise stated, the first outer portion 106 and second outer portion 108 can be detachable such that a width-profile of the gait trainer 100 is reduced. When assembled, the frame 102 comprises a T-shape base. The T-shape provides maximum stability to gait trainer 100 while allowing the user to easily access horizontal support 120 (e.g., seat) in the sitting configuration. This is especially beneficial for the user that uses a wheelchair to be wheeled up to the horizontal support 120 and be easily transferred from the wheelchair to the horizontal support 120.

FIG. 2 illustrates a lateral view of gait trainer 100 of FIG. 1, according to certain embodiments of the present disclosure. In the illustrated embodiment, multiple settings, and distances of the gait trainer 100 can be adjusted, to customize or be fit to the user of gait trainer 100.

In the illustrated embodiment, a lateral distance 166 is the distance between the seat (e.g., horizontal support 120) and a forward end of gait trainer 100 (e.g., flywheel 134, or the terminal end of the base or frame 102).

Lateral distance 166 can correspond to a leg length of the user of gait trainer 100 and can be adjusted. For instance, in embodiments, lateral distance 166 can be increased or decreased by the user of gait trainer 100 or an assistant (e.g., physical therapist). Otherwise stated, the user of gait trainer 100 can customize, or adjust the distance between the user and foot pedals 156. In such a way, the gait trainer 100 can be customize to the leg length of the user of gait trainer 100.

Mechanisms for adjusting lateral distance 166 (and other distances and lengths of gait trainer 100) can be varied and will be further described with respect to each mechanism. Generally speaking, in some embodiments, adjustment mechanisms can include sliding tracks, telescopic extensions, or other suitable adjustment mechanisms that allow for fixable modification of distances and lengths. Actuators for facilitating adjustments can include electric motors, hydraulic systems, or pneumatic systems that allow for adjusting elements of gait trainer 100. These features can allow for natural and effective posturing and gait training using gait trainer 100.

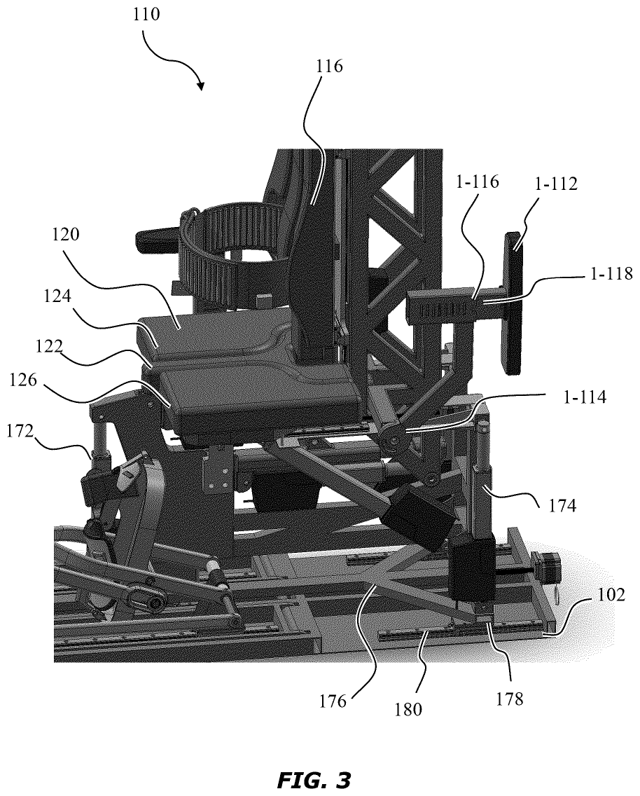

Vertical distance 168 is the distance from the base or floor to the seat (e.g., horizontal support 120). Vertical distance 168 of horizontal support 120 (e.g., the seat) can correspond to a tibial length, or the distance between the user's knee and foot, of the user of gait trainer 100. Vertical distance 168 can be adjusted via actuators, to enhance or optimize flexion at the knee. Adjustment will be further described with respect to FIGS. 3-4.

Vertical distance 170 is the height of kinematic assembly 130, which can be adjusted via kinematic assembly actuators 162. In some embodiments, vertical distance 170 can correspond to a distance or height of crankshaft 138 with respect to the frame 102 of the gait trainer 100. Adjustment of vertical distance 170 can be reflected in the inclination of the gait provided by gait trainer 100. For instance, a larger vertical distance 170 can mimic climbing stairs, or the biomechanics of movement up an inclined surface. Conversely, a shorter vertical distance 170 can imitate movement, or the biomechanics of movement, on a flat or declined surface. Vertical distance 170 can thus be adjusted to imitate various conditions.

Stride adjuster length 158 is the adjustable length of stride adjusters 144 and can correspond to a length of stride of the gait provided by gait trainer 100.

When in use, the user of gait trainer 100 can provide motion to flywheel 134 through drive handles 146 and/or foot pedals 156. For instance, forced movement of drive handles 146 and/or foot pedals 156 can in turn rotate crankshaft 138 and drive wheel 136 through stride adjusters 144. For instance, movement of drive handles 146 around hinges 150 can apply a rotational force to stride adjusters 144 through first drive transfer bar 140 and second drive transfer bar 142.

In some embodiments, gait trainer 100 can further include a resistive mechanism 164 to induce or apply resistance into the rotation of flywheel 134. Otherwise stated, resistive mechanism 164 can make it harder or easier for the user of the system to pedal foot pedals 156 or move drive handles 146, thereby providing a varied training experience. The provided resistance can vary in magnitude or level applied.

Resistive mechanism 164 can be a magnetic, electrical, or mechanical (e.g., frictional) mechanism. Resistive mechanism 164 can be dynamically, or programmatically, adjusted to meet the needs of the user of gait trainer 100. By adjusting resistive mechanism 164, gait trainer 100 can simulate varied movement conditions, e.g., such as uphill climbs or weighted walks. In some embodiments, the resistive mechanism 164 may be added only a single side, such as the left arm and leg or the right arm and leg. This enables the user to strengthen a single side of their gate.

A control interface 152 (e.g., a controller or control system) can contain a computer or electronics (e.g., such as an iPad, tablet, or similar computer-user interface), for the user to adjust lengths, distances, settings, configurations, and/or resistive settings associated with the gait trainer 100. The control interface 152 can contain internet connectivity and remote accessibility so that 1) clinician/therapist/doctor can adjust settings and monitor user progress; 2) Users may connect with other users/trainers in collaborative setting.

A support 154 can extend from the vertical support 116 to position the control interface 152 near the user of gait trainer 100. In some embodiments, support 154 can be adjustable to place control interface 152 in various positions and configurations with respect to the user of gait trainer 100.

FIG. 3 illustrates a perspective view of a portion of the user support assembly 110 of FIG. 1, according to certain embodiments of the present disclosure. In the illustrated embodiment, horizontal support 120 can include mechanisms for adjusting the support's vertical and lateral position.

To adjust horizontal support 120, a lift actuator 172, a lift actuator 174, and/or others not seen in FIG. 3 can increase or decrease in length based on a user adjustment. Adjustment of the lift actuators 172, 174, and/or others can raise or lower the vertical distance between the horizontal support 120 and the frame 102.

In addition, user support assembly 110 and horizontal support 120 can include a mechanism to horizontally adjust the horizontal support 120. For example, based on user input, the lift actuators (e.g., lift actuator 172) supporting horizontal support 120 can translate in the lateral direction. For instance, in some embodiments, the lift actuators supporting horizontal support 120 can rest on a sub-frame 176. Sub-frame 176 can itself rest on one or more guides and tracks (e.g., such as guide 178 and track 180). Accordingly, sub-frame 176 and horizontal support 120 can move laterally, as one body.

As previously discussed, the mechanisms for adjusting distances and lengths of user support assembly 110 can include sliding tracks, telescopic extensions, electric motors, hydraulic systems, or pneumatic systems, and so on.

In the illustrated embodiment, horizontal support 120 is divided into separate portions. For example, horizontal support 120 can include middle portion 122, a first outside portion 124, and a second outside portion 126.

In the seated configuration of user support assembly 110 seen in FIGS. 1-3, middle portion 122, first outside portion 124, and second outside portion 126 can be in alignment so as to form a uniform upper surface for the user of gait trainer 100 to sit on.

One or more arm rests (e.g., arm rest 1-112) can be attached to the user support assembly 110. Each arm rest (e.g., arm rest 1-112) can be adjustable. For instance, in some embodiments, arm rests 1-112 can include an adjustment mechanism 1-116 for adjusting the length of support portion 1-118. Adjustment mechanism 1-116 can thus be used to adjust a height, or vertical distance of the arm rests 1-112 with respect to the horizontal support 120. A joint 1-114 can be used to swivel arm rests 1-112 into a removed position (as arm rest 1-112 is seen in FIG. 3). Accordingly, arm rests of the gait trainer 100 (e.g., arm rest 1-112) can be transitioned from an active position to a removed position, and vice-versa. In some embodiments, one or more arm rests 1-112 are mounted with an angled hinge, allowing the user to extend or retract the one or more arm rests 1-112 in one motion. The angled mounting system also transfers downward force on the arm rests 1-112 into vertical support 116, thus reducing the material of one or more arm rests 1-112.

FIG. 4 illustrates a standing configuration of gait trainer 100 of FIG. 1, according to certain embodiments of the present disclosure. In the illustrated embodiment, middle portion 122 of the horizontal support 120 is in alignment with lower portion 114 of the vertical support 116. A standing configuration (as seen in FIG. 4) of gait trainer 100 can be engaged or disengaged by the user of gait trainer.

Within the standing configuration, lower actuators 190 and upper actuators 192 of user support assembly 110 can be engaged to lift, or articulate, middle portion 122 of horizontal support 120 from a horizontal configuration and into a vertical configuration (or vice-versa). Vertical support 116 can also be lifted by the same actuators. In some embodiments, first outside portion 124 and second outside portion 126 can remain stationary in a horizontal configuration as middle portion 122 is lifted. Otherwise stated, within the horizontal configuration the horizontal support 120 and frame 102 can be parallel to one another; within the vertical configuration the horizontal support 120 and vertical support 116 or frame 102 can be arranged substantially perpendicular to one another. In some embodiments, middle portion 122 can be referred to as an inclining portion, first outside portion 124 and/or second outside portion 126 can be referred to as stationary portions.

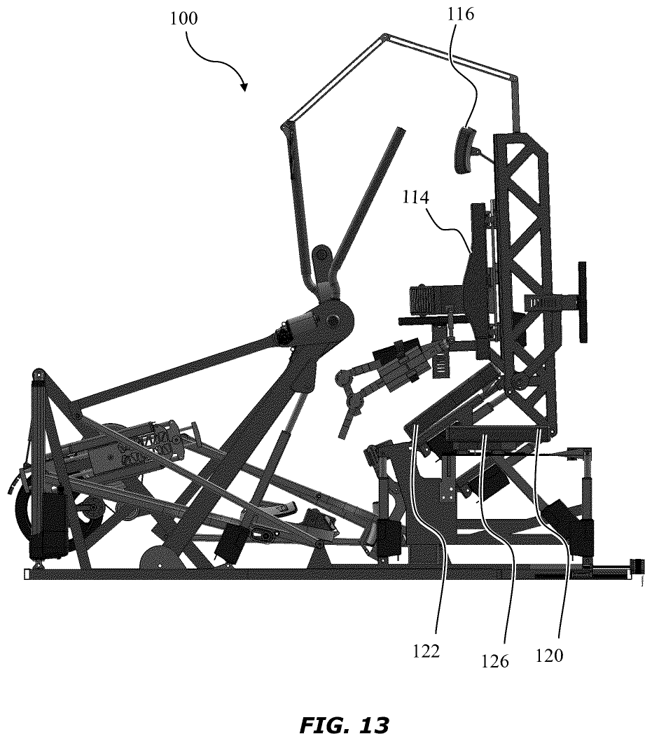

In some cases, middle portion 122 can be lifted, inclined, or articulated to a position or orientation that is anywhere between the horizontal configuration or orientation and the vertical configuration or orientation. For instance, in some embodiments, middle portion 122 can be inclined such that user support assembly 110 is in an intermediate configuration or orientation, e.g., such that middle portion 122 is articulated between a zero degree and a 90-degree incline. In some embodiments, the middle portion 122 may be articulated between a zero degree and a 105-degree incline. An embodiment of such a configuration or orientation can be seen with respect to FIG. 13.

Since middle portion 122 comprises a T-shape and first outside portion 124 and second outside portion 126 remain in a horizontal or flat portion, this allows the user to stride and move each leg, without impeding or blocking motion to the rear, or rear, of vertical support 116. In other words, the legs of the user do not engage with middle portion 122 during ambulatory gait motion. Thus, middle portion 122 of horizontal support 120 can support the user of gait trainer 100, both in the seated configuration and standing configuration, without impeding a full range of motion of the user's legs.

Within any configuration of user support assembly 110, the harness (e.g., belt 194) and exoskeleton 196 can continue to support the user of gait trainer 100.

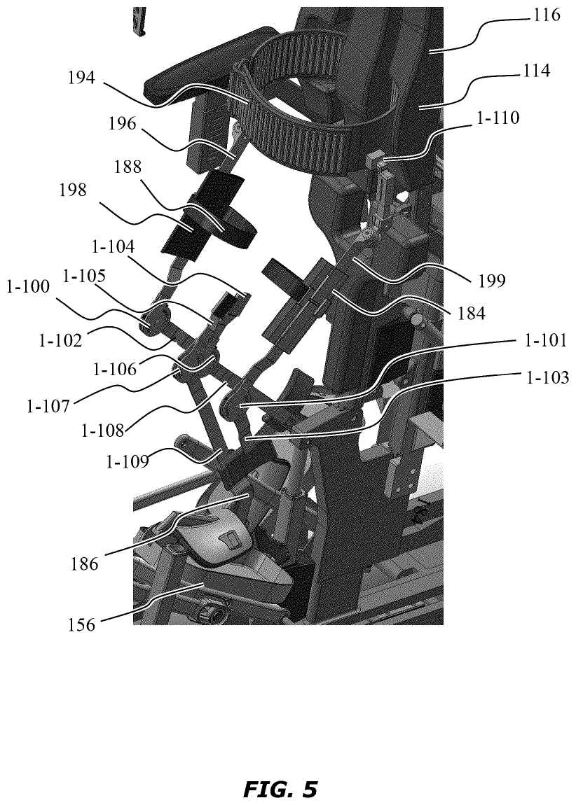

FIG. 5 illustrates a harness (e.g., belt 194) and exoskeleton 196 of the gait trainer 100 of FIG. 1, according to certain embodiments of the present disclosure. In the illustrated embodiment, restraints, such as a harness (e.g., belt 194) and exoskeleton 196 can be seen. Each restraint can be used to support or constrain the user (or the movement of the user) of the gait trainer 100.

Belt 194 can be attached to lower portion 114 of vertical support 116. In some embodiments, belt 194 can be used by the user of gait trainer 100 to tighten around the user's abdomen. Otherwise stated, belt 194 can fix the user to lower portion 114 and the user support assembly 110.

Exoskeleton 196 can be used to constrain the user of gait trainer 100 to a particular range of motion. For instance, in some embodiments, exoskeleton 196 can be attached to the user's legs to keep the user's ambulatory gait within a linear path. Otherwise stated, exoskeleton 196 can provide lateral support, and prevent unwanted, or undesired, lateral movement. For instance, exoskeleton 196 can prevent the user's knees, legs, or hips from buckling to the side. Such a constraint can enhance stability and controllability.

In some cases, exoskeleton 196 can include an inner and outer guide. Otherwise stated, in some cases, exoskeleton 196 can attach to both the inside and outside of the user's legs. In alternate embodiments, exoskeleton 196 can be entirely exterior or entirely interior to the user's legs.

In some embodiments, exoskeleton 196 can be connected directly to the belt 194 (e.g., via attachment point 1-110). Alternatively, exoskeleton 196 can be connected directly to any other points of the user support assembly 110, such as the vertical support 116 and the like. Exoskeleton 196 can be both removable and adjustable. For example, the exoskeleton 196 may be attached to the user's legs before the user seats on gait trainer 100. The exoskeleton 196 may then be coupled to gait trainer 100 to reinforce the exoskeleton 196.

As seen in FIG. 5, exoskeleton 196 includes outer guides 184 and inner guides 186. Both pairs of guides can include straps 188 for each portion of exoskeleton 196 to the user's legs.

Outer guides 184 can include first outer portion 198 and first outer portion 199. In some embodiments, first outer portion 198 and first outer portion 199 can correspond to the user's thigh and be extendable and adjustable to fit to the user's thigh. First outer joint 1-100 and first outer joint 1-101 can connect first outer portion 198 and first outer portion 199 to second outer portion 1-102 and second outer portion 1-103. Second outer portion 1-102 and second outer portion 1-103 can correspond to the user's shins and include straps to attach to such. Second outer portion 1-102 and second outer portion 1-103 can be adjustable in length.

In some cases, outer guides 184 can include sufficient structural support to prevent the user's knees, legs, or hips, from buckling outwards.

Inner guides 186 can include first inner portion 1-104 and first inner portion 1-105. In some embodiments, first inner portion 1-104 and first inner portion 1-105 can correspond to the user's thigh and be extendable and adjustable to fit to the user's thigh. First inner joint 1-106 and first inner joint 1-107 can connect first inner portion 1-104 and first inner portion 1-105 to second inner portion 1-108 and second inner portion 1-109. Second inner portion 1-108 and second inner portion 1-109 can correspond to the user's shins and include straps to attach to such. Second inner portion 1-108 and second inner portion 1-109 can be adjustable in length, and rotationally attached to foot pedals 156.

In some cases, inner guides 186 can include sufficient structural support to prevent the user's knees, legs, or hips, from buckling inwards.

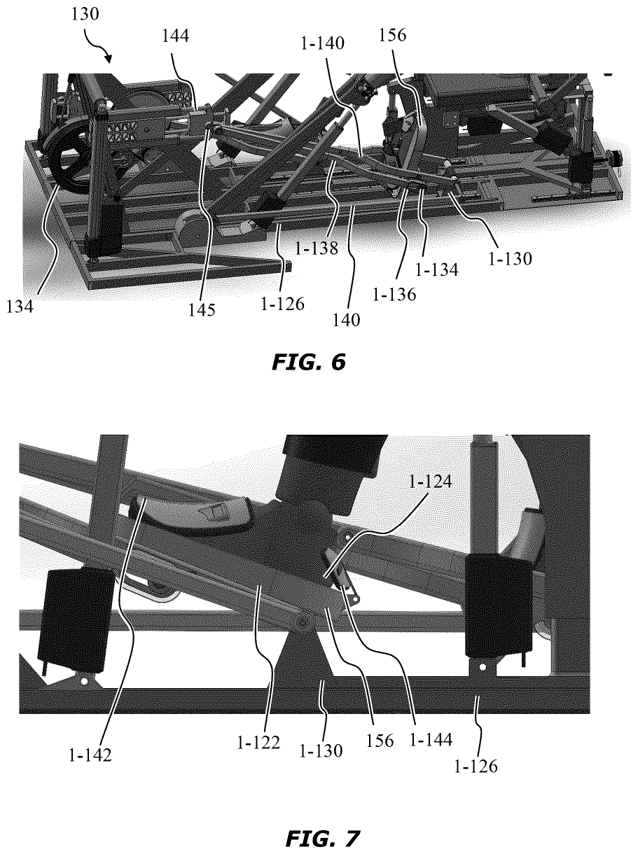

FIG. 6 illustrates kinematic assembly 130 of FIG. 1, according to certain embodiments of the present disclosure. As seen in FIG. 6, foot pedals 156 are linked to stride adjusters 144 through outer linkage bars 1-138 and inner linkage bars 1-140. A forward end of outer linkage bars 1-138 and inner linkage bars 1-140 are coupled to stride adjusters 144 via a linkage bar 145 such that the forward end of outer linkage bars 1-138 rotates around the forward end of inner linkage bar 1-140. Movement of the foot pedals 156 can thus drive rotation of stride adjusters 144 and flywheel 134. In some cases, foot pedals 156 can be coupled to guides 1-130, which can traverse track 1-126 as the user operates the gait trainer.

In a true or natural gait, a walker or runner's movement can first include a heel-strike to the ground, followed by a continuous rolling motion from heel to toe, and terminate with a push-off from the toe. As will be further described with respect to FIGS. 7-9, kinematic assembly 130 can be configured to replicate a true, ambulatory gait or ambulatory gait pattern.

Track 1-126 can ensure that motion of the foot pedals 156 is linear and controlled and provide movement that simulated or imitates a natural gait. The guides 1-130 serve as a stabilizing component, maintaining the alignment of the foot pedals as they move along track 1-126.

Guides 1-130 can be rotationally coupled to inner linkage bars 1-140. Guide 1-130 is also coupled to first drive transfer bar 140. Foot pedals 156 can be rotationally coupled to outer linkage bars 1-138 through a slot 1-136 and pin 1-134 and can be rotationally coupled to the inner linkage bars 1-140. The rotational coupling of foot pedals 156 to inner linkage bars 1-140 is near a forefoot or ball of the user's foot. The sliding rotationally coupling of foot pedals 156 to the outer linkage bars 1-138 is in the forefoot of the user's foot and forward the rotational coupling of foot pedals 156 to inner linkage bars 1-140. The coupling between slot 1-136 and pin 1-134 can enable the foot pedals to adjust their angle and position in response to the user's movements. Otherwise stated, pin 1-134 can operate as a pivot point to facilitate natural movement of the user's gait. The pin 1-134 slides in the slot 1-136 during gait movement which changes the pivot point of the pin 1-134 during the gait movement. As noted above, the rotational coupling of foot pedals 156 to outer linkage bars 1-138 is forward the rotational coupling between foot pedals 156 to inner linkage bars 1-140 during the entire gait motion including the sliding of pin 1-134 in slot 1-136. Accordingly, guides 1-130 and track 1-126 can be configured to allow the user of gait trainer 100 to imitate the motion or movement pattern of a natural ambulatory gait pattern.

As will be further described with respect to FIGS. 7-9, kinematic assembly 130 can be configured to replicate this true or natural ambulatory gait pattern. For instance, a first configuration of the kinematic assembly can be configured to simulate a heel-strike motion of an ambulatory gait pattern and a second configuration of the kinematic can be configured to simulate a toe push-off motion of an ambulatory gait pattern. Additionally, kinematic assembly 130 can facilitate a continuous or fluid transition motion between the first configuration and the second configuration, or between the second configuration and the first configuration.

FIG. 7 illustrates a forward position of foot pedal 156 of gait trainer 100 of FIG. 1, according to certain embodiments of the present disclosure. In the illustrated embodiment, left pedal 1-122 of foot pedals 156 can be seen in a forward-most position of the user's gait.

As previously discussed, left pedal 1-122 can be linked to inner linkage bars 1-140, which can be rotationally linked to guide 1-130 and track 1-126. In some embodiments, foot pedals 156 can include constraints for the user's foot. For example, front constraining portion 1-142 and rear constraining portion 1-144 can serve to constrain the foot (e.g., heel 1-124) of the user of gait trainer 100.

A forward-most position of left pedal 1-122, as seen in FIG. 7, can serve to simulate a heel-strike position by positioning the user's foot in a heel-first landing typical of a natural gait. For example, left pedal 1-122 can be angled to imitate the initial contact phase, or heel-strike (or heel-strike position) of a natural or true, ambulatory gait pattern. The heel-strike can occur around where guide 1-130 rotationally couples to outer linkage bars 1-138. Such an imitative ability can facilitate natural movement and training when gait trainer 100 is in use.

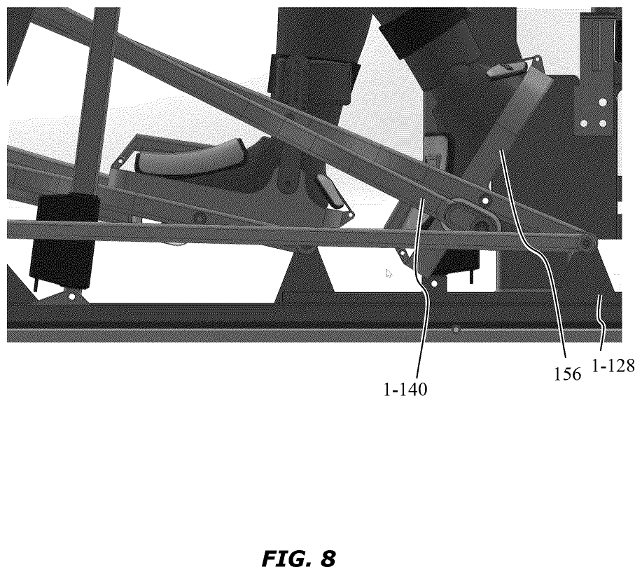

FIG. 8 illustrates a rearward position of a foot pedal of the gait trainer 100 of FIG. 1, according to certain embodiments of the present disclosure. In the illustrated embodiment, left pedal 1-122 of foot pedals 156 can be seen in a rear-most position of the user's gait.

A rear-most position of left pedal 1-122, as seen in FIG. 8, can serve to simulate a toe push-off position by positioning the user's foot into a toe-only contact position (e.g., a toe push-off position) of a natural gait. For example, left pedal 1-122 can be angled to imitate the final push-off, or toe-only contact position of a natural or true, gait. For example, pin 1-134 disposed at a forward end of slot 1-136 at toe push-off and pin 1-134 slides to a rear end of slot 1-136 after toe push-off and the user's foot is in air. After heel-strike, pin 1-134 slides from the rear of slot 1-136 to the front of slot 1-136 in anticipation of toe push-off.

Between FIG. 7 and FIG. 8, gait trainer 100 can smoothly transition the user's heel from heel to toe, as the foot is pulled back during a natural stride.

FIG. 9 illustrates an elevated position of the kinematic assembly 130 of FIG. 1, according to certain embodiments of the present disclosure. In the illustrated embodiment, a front end of kinematic assembly 130 can be raised or lowered via kinematic assembly actuators 162. As previously discussed, vertical distance 170 can be adjusted via kinematic assembly actuators 162.

In some embodiments, a front angle of machine can be increased (e.g., kinematic assembly 130 can be lifted via kinematic assembly actuators 162). Accordingly, the gait experienced by the user can correspond to a walk, to a hike (e.g., up to an 8-inch step), as adjusted by the user of gait trainer 100.

FIG. 10 illustrates a lowered configuration of drive handles 146 of gait trainer 100 of FIG. 1, according to certain embodiments of the present disclosure. In the illustrated embodiment, drive handles 146 are rotated about hinges 150, into a lowered configuration. The user may also use drive handles 146 in the lowered configuration while sitting.

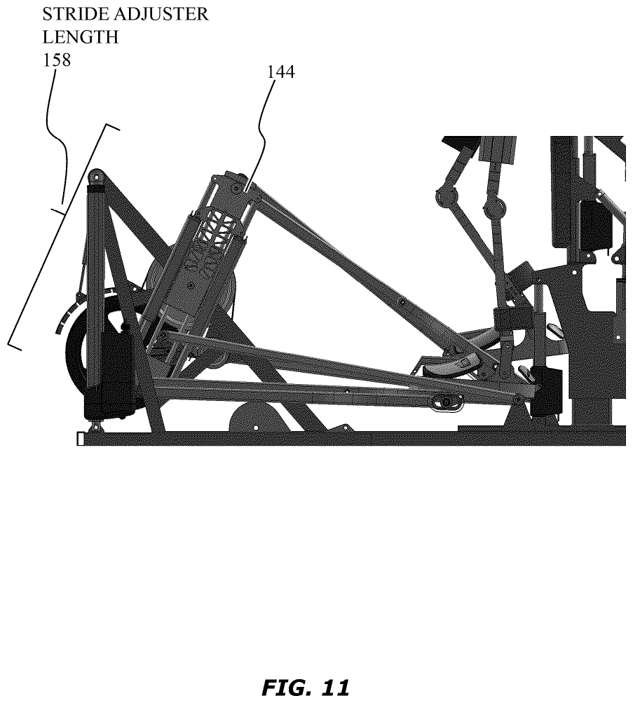

FIG. 11 illustrates a configuration including an increased stride length, of gait trainer 100 of FIG. 1, according to certain embodiments of the present disclosure. In the illustrated embodiment, stride adjusters 144 are configured into a maximum length. Accordingly, stride adjuster length 158 is at a maximum.

FIG. 12 illustrates a configuration including a decreased stride length, of the gait trainer 100 of FIG. 1, according to certain embodiments of the present disclosure. In the illustrated embodiment, stride adjusters 144 are configured into a minimum length. Accordingly, stride adjuster length 158 is at a minimum.

FIG. 13 illustrates an intermediate configuration of gait trainer 100 of FIG. 1, according to certain embodiments of the present disclosure. In some embodiments, gait trainer 100 can be set into any configuration resting between the seated configuration and the standing configuration. For instance, within the illustrated configuration, middle portion 122 of horizontal support 120 can be partially raised, and out of alignment with the outside portions (e.g., outside portion 126).

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

What is claimed is:

1. A gait trainer comprising:
a user support assembly disposed on a base, the user support assembly comprising:
a horizontal support configured to seat a user of the gait trainer; and
an actuator attached to the horizontal support, wherein the actuator is configured to articulate at least a portion of the horizontal support from a horizontal configuration into a vertical configuration;
a kinematic assembly configured to transmit a physical input from the user of the gait trainer to a flywheel of the kinematic assembly; and
a restraint configured to constrain the user within the user support assembly during use of the gait trainer.

2. The gait trainer of claim 1, wherein the base comprises:
a middle portion;
a first outer portion detachably attached to the middle portion; and
a second outer portion detachably attached to the middle portion;
wherein the first outer portion and second outer portion are detachable such that a width-profile of the gait trainer is reduced.

3. The gait trainer of claim 1, wherein the horizontal support comprises:
an inclining portion; and
a stationary portion;
wherein the actuator is configured to incline the inclining portion from the horizontal configuration into the vertical configuration, or to a configuration anywhere between the horizontal configuration and the vertical configuration;
wherein the gait trainer is configured to be used by the user in a standing position when the inclining portion is in the vertical configuration; and
wherein the gait trainer is configured to be used by the user in a sitting position when the inclining portion is in the horizontal configuration.

4. The gait trainer of claim 1, wherein the horizontal support comprises an adjustment mechanism configured to adjust at least one of a vertical distance of the horizontal support from the base, or a lateral distance of the horizontal support from a terminal end of the gait trainer.

5. The gait trainer of claim 1, wherein the kinematic assembly comprises:
a pair of foot pedals;
a pair of guides coupled to the pair of foot pedals, wherein the guides are configured to facilitate a movement of the foot pedals that imitates an ambulatory gait pattern; and
a pair of stride adjusters for adjusting the length of the ambulatory gait pattern.

6. The gait trainer of claim 5, wherein the imitated ambulatory gait pattern comprises a heel-strike position and a toe push-off position.

7. The gait trainer of claim 1, wherein the kinematic assembly comprises:
a kinematic assembly actuator configured to raise or lower a height of a crankshaft of the kinematic assembly with respect to the base.

8. The gait trainer of claim 1, wherein the restraint further comprises:
a harness configured to constrain the user to a vertical support of the user support assembly; and
an exoskeleton configured to constrain the user from lateral movement.

9. The gait trainer of claim 8, wherein the exoskeleton comprises an inner portion coupled to an interior of the user's legs.

10. The gait trainer of claim 8, wherein the exoskeleton comprises an exterior portion coupled to an exterior of the user's legs.

11. A gait trainer comprising:
a base;
a user support assembly disposed on the base, the user support assembly comprising:
a horizontal support configured to support a user of the gait trainer;
wherein within a first configuration of the user support assembly the horizontal support and base are parallel to one another;
wherein within a second configuration of the user support assembly the horizontal support and base are angled relative to each another; and
wherein a portion of the horizontal support is configured to articulate from a first orientation corresponding to the first configuration or a second orientation corresponding to the second configuration, to an intermediate orientation corresponding to an intermediate configuration of the user support assembly, wherein the intermediate orientation is between the first orientation and the second orientation; and
a kinematic assembly configured to transmit a physical input from the user of the gait trainer to a flywheel of the kinematic assembly.

12. The gait trainer of claim 11, wherein within the intermediate orientation the portion of the horizontal support is articulated between 0 degrees and 90 degrees from the first orientation.

13. The gait trainer of claim 11, wherein the first configuration is a seated configuration of the gait trainer; wherein the second configuration is a standing configuration of the gait trainer.

14. The gait trainer of claim 11, further comprising an exoskeleton configured to constrain the user of the gait trainer from lateral movement.

15. The gait trainer of claim 11, further comprising a control system configured to enable the user to transition the gait trainer from the first configuration or the second configuration to the intermediate configuration.

16. The gait trainer of claim 11, wherein the horizontal support comprises:
an inclining portion comprising a T-shape; and
a stationary portion;
wherein the inclining portion is configured to incline from the first orientation to the second orientation, and
wherein when the inclining portion is disposed in a second configuration, the inclining portion does not engage with legs of the user during use of the gait trainer.

17. A gait trainer comprising:
a user support assembly disposed on a base and configured to support a user of the gait trainer;
a kinematic assembly disposed on the base, the kinematic assembly comprising:
a flywheel;
a linkage mechanism operatively connected to the flywheel; and
a pair of foot pedals operatively attached to the linkage mechanism;
wherein the linkage mechanism is configured to transmit a physical input from the pair of foot pedals to the flywheel of the kinematic assembly; and
wherein a movement pattern of the kinematic assembly is configured to simulate a natural ambulatory gait pattern.

18. The gait trainer of claim 17, wherein the movement pattern comprises:
a first configuration of the kinematic assembly configured to simulate a heel-strike motion of an ambulatory gait pattern; and
a second configuration of the kinematic configured to simulate a toe push-off motion of an ambulatory gait pattern.

19. The gait trainer of claim 18, wherein the movement pattern further comprises a continuous transition motion between the first configuration and the second configuration, or between the second configuration and the first configuration.

20. The gait trainer of claim 17, wherein the kinematic assembly further comprises a resistance system operatively connected to the flywheel, the resistance system configured to vary the resistance applied to the flywheel.
